(19) United States
(12) Patent Application Publication
(10) Pub. No.: US 2012/0193371 A1
(43) Pub. Date: Aug. 2, 2012

(54) PROCESS FOR PRODUCING CANNED PRODUCT AND CANNED PRODUCT

(75) Inventor: Guangde Lai, Shanghai (CN)

(73) Assignee: Akzo Nobel Swire Paints(Shanghai) Limited

(21) Appl. No.: 13/388,735

(22) PCT Filed: Aug. 4, 2010
(86) PCT No.: PCT/CN2010/075696

§ 371 Date: Apr. 16, 2012

(30) Foreign Application Priority Data
Aug. 12, 2009 (CN) 200910163842.8

(51) Int. Cl. B44D 3/12; B65B 1/04; B65D 43/04

(52) U.S. Cl. 220/801; 206/1.7; 53/467

(57) ABSTRACT

A process for producing a canned product comprises the steps of: providing a can (1), a lid (2) and contents to be filled in the can (1), the can (1) having a mouth (13), and the lid (2) having an extension (21) that is able to fit the mouth (13) to seal the can (1); filling the can (1) with the contents; fitting the lid (2) in the mouth (13) of the can (1), such that the extension (21) of the lid (2) forms a fit with a sidewall (11) of the mouth (13). The process further comprises the step of forming at least one bulge (22) on one of the extension (21) of the lid (2) and the sidewall (11) of the mouth (13) after fitting the lid (2) in the mouth (13) of the can (1), wherein while the lid (2) is removed from the can (1), the convex surface of the at least one bulge (22) is engaged with the other of the extension (21) of the lid (2) and the sidewall (11) of the mouth (13) in such a way that the extension (21) and/or the sidewall (11) is destroyed. A canned product produced by the process is also disclosed.

### FIELD OF THE INVENTION

The invention relates to a process for producing a canned (tinned) product or generally a product packed in a container, and especially a canned paint product. The invention also relates to a canned product, especially a canned paint product, produced by the process.

### BACKGROUND OF THE INVENTION

As a conventional process for producing a canned paint product, a can is filled with paint, thereafter a lid is fitted into a mouth of the can via a press. The canned paint product thus produced has a disadvantage that, since the fit force between the lid and the can is produced merely by the press fit between a surface of the lid and an opposed surface of the can, which surfaces are substantially parallel and abut against each other, the lid is liable to escape from the can when the canned paint product is subject to shake or vibration during, for example, handling process or transportation, or is tipped over by accident, etc., causing paint to leaking or contamination.

Another disadvantage of the conventional canned paint product lies in that, the used cans and lids may often be reused by others to make counterfeit paint products in the market, thereby damaging the business image and interests of the paint manufacturer. Existing anti-counterfeit technologies include laser printing or anti-counterfeit label and so on, however, these technologies are complicated and expensive.

### SUMMARY OF THE INVENTION

The invention aims to overcome the prior art disadvantages as set forth above, that is, to provide a simple and low-cost process for producing a canned product, and a canned product produced by this process, the lid of which canned product is not liable to escape from the can, and the lid and the can themselves have an anti-counterfeit function. The canned product according to the invention may include a variety of products, and is especially a canned paint product.

According to the invention, the above object is achieved by such a process for producing a canned product, comprising the steps of: (a) providing a can, a lid and contents to be filled in the can, the can having a mouth, and the lid having an extension that is able to fit the mouth to seal the can; (b) filling the can with the contents; (c) fitting the lid in the mouth of the can, such that the extension of the lid forms a fit with a sidewall of the mouth; the process is characterized by further comprising the step of: (d) forming at least one bulge on one of the extension of the lid and the sidewall of the mouth after fitting the lid in the mouth of the can, wherein while the lid is removed from the can, the convex surface of the at least one bulge is engaged with the other of the extension of the lid and the sidewall of the mouth in such a way that the extension and/or the sidewall is destroyed.

According to the process of the invention, by making at least one bulge on the extension of the lid or the sidewall of the can in a simple way and at a low cost, wherein the bulge being protruded to such an extent that it can be engaged with or even embedded into the mouth or extension during removal of the lid, a more reliable engagement between the lid and the mouth may be achieved, thereby increasing the fit force between the lid and the mouth and reducing the risk that the lid will escape from the can. Further, the sidewall of the mouth and/or the extension is destroyed after the lid is removed. As used herein, “destroyed” means a visible evidence (especially, scratch mark) is produced on the extension or the sidewall, and/or the bulges themselves are squashed, etc., due to the relatively high pressure caused by the fact that the convex surface of the bulge tightly abuts against and slides on the extension or the sidewall while the lid is removed from the can. The evidence of being “destroyed” may also include the damage to the edge of the lid due to an increased force applied by a tool for removing the lid, for example, caused by an increase of the fit force between the lid and the mouth. Thus, on the one hand, the unique bulges on the lid can serve as an anti-counterfeit appearance characteristic of the canned product of the invention. On the other hand, the destroyed can and lid cannot be reused by others any more, and even if they are reused for counterfeit product, it can be easily determined whether the lid has ever been removed from the can by checking and analyzing the “destroyed” evidence or scratch mark on the lid and the mouth after the lid is removed, thus serving for an anti-counterfeit purpose.

According to an advantageous configuration, the step (d) may comprise extending parts of the surface of the extension of the lid in the direction towards the sidewall such that the at least one bulge is protruded. As such, it is possible to form the bulges in an easy, rapid way, at a low cost and with simple tools.

According to another advantageous configuration, each of the at least one bulge may generate a concave on the sidewall while the extension is being extended, the concave and the bulge being engaged with each other via their matching shapes. Thus, the engagement force between the bulge and the concave will be further increased by their matching shapes.

Advantageously, a plurality of the bulges may be formed, such that the engagement force between the lid and the mouth can be increased during removal of the lid. Preferably, at least five bulges are formed.

Advantageously, the plurality of the bulges may be evenly distributed along the circumference of the lid or the mouth. This helps to evenly distribute the engagement force between the lid and the mouth along the circumference of the can.

Advantageously, the convex surface of the bulge may be formed as a smooth surface without any sharp protrusion. This can prevent any protection film, that possibly exists on the convex surface, from being damaged.

Optionally, the process may further comprise a step of fixedly disposing a collar on the can body of the can before fitting the lid in the mouth of the can. In this case, a collar made from proper material may be selected for serving as the mouth of the can, so as to facilitate the fit between the mouth and the lid.

Correspondingly, the invention provides a canned product produced by the above process, the canned product comprising a can having a mouth, a lid having an extension, and contents filled in the can, the lid being fitted in the mouth such that the extension forms a fit with a sidewall of the mouth to seal the can; it is characterized in that, one of the extension of the lid and the sidewall of the mouth has at least one bulge, and while the lid is removed from the can, the convex surface of the at least one bulge is engaged with the other of the extension of the lid and the sidewall of the mouth in such a way that the extension and/or the sidewall is destroyed.

According to an advantageous configuration, the mouth may include a collar that is fixedly disposed on the can body of the can. The collar may be made from a different material from that of the can body.

Advantageously, the mouth and/or the lid may be made of metal material.

Other advantageous configurations of the canned product according to the invention may be obvious to those skilled in the art based on the advantageous configurations of the process according to the invention as discussed above.

### BRIEF DESCRIPTION OF THE DRAWINGS

The foregoing and other features and advantages of the invention will be apparent from the following description of the embodiments thereof with reference to the drawings, wherein:

FIG. 1 shows an exploded sectional view of a can and a lid according to an embodiment of the invention, in a state before being fitted together;

FIGS. 2 shows a sectional view of the can and the lid according to the embodiment of the invention in a fitted state, in which only the right half portion of the two half portions that are symmetric with respect to the central axis is shown; and

FIG. 3 shows a bottom view of the lid in FIG. 2.

### DETAILED DESCRIPTION OF THE INVENTION

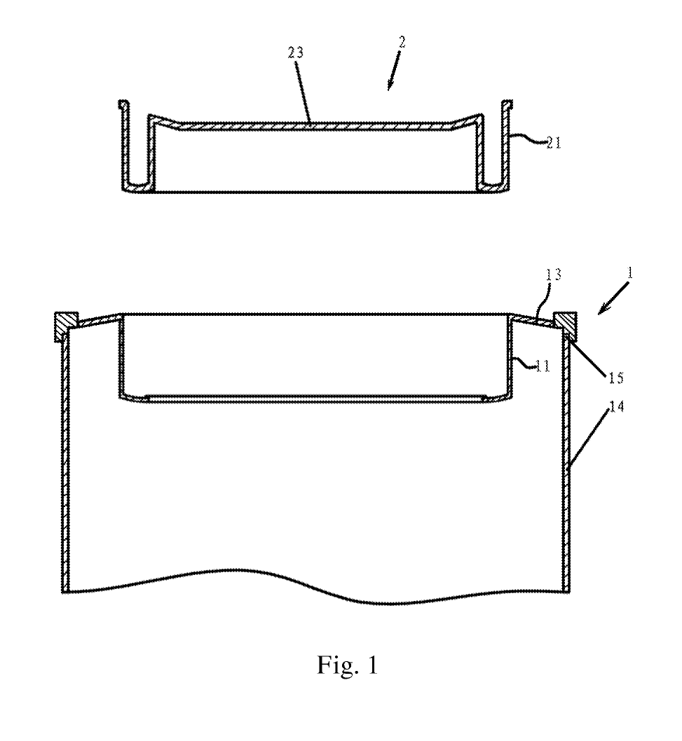

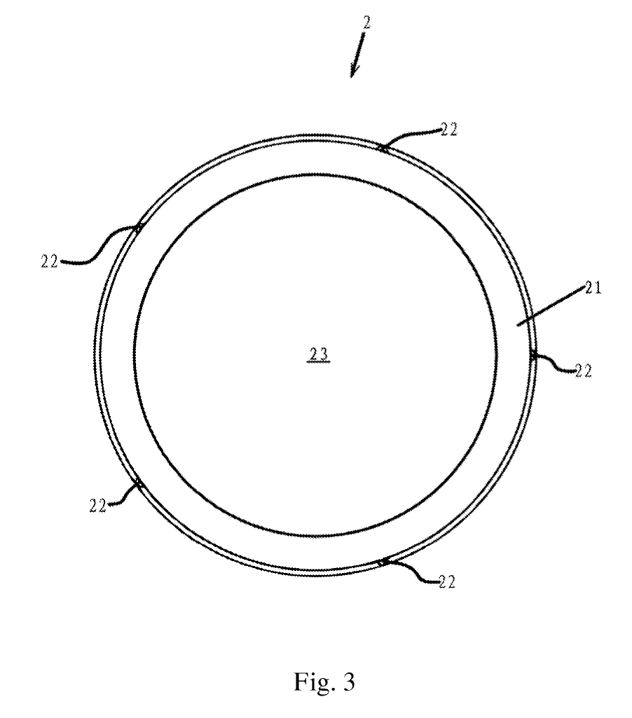

FIG. 1 shows an exploded view of a lid and a can of a canned product (for example, a canned paint product) according to an embodiment of the invention. In the embodiment, the lid is in a circular shape and the can is in a cylindrical shape. FIG. 1 is a sectional view taken along a plane that passes through the central axis of the lid and the can. It will be appreciated by a person skilled in the art that the lid and the cross section of the can are not limited to a circular shape, and may be any other proper shapes, such as square or rectangular shape, etc.. As shown in FIG. 1, a can body 14 of the can 1 (partially shown) has a mouth 13 that receives the paint and matches the lid. The mouth 13 may be a part formed integrally with the can body 14 of the can 1 by the same material (same metal, for example); however, it may also be a part that is separate from the can body 14 and fixedly disposed on the can body 14 by any proper means known in the art and formed of a same or different material from that of the can body 14. As an example, in the embodiment, as shown in FIG. 1, the mouth is formed by a separate collar 13, which is fixedly joined to the can body 14 at a top edge 15 thereof and made from a same or different metal material from that of the can body 14. It will be understood that, the can body 14 and the mouth 13 of the can 1, and the lid 2 may be respectively formed from any proper material depending on specific requirements regarding property and strength of the contents in the can, environmental protection, and costs, etc., without limitation to metal material. The mouth 13 has a sidewall 11, which takes a cylindrical shape with a generally vertical orientation in the embodiment. As shown in FIGS. 1 and 3, in the embodiment, the lid 2 comprises a circular plate-like lid body 23 and an extension 21 extending generally vertically around the lid body 23. When the lid 2 and can 1 are fitted together, the extension 21 abuts against the sidewall 11 of the mouth 13 in such a way that the lid 2 properly seals the can 1.

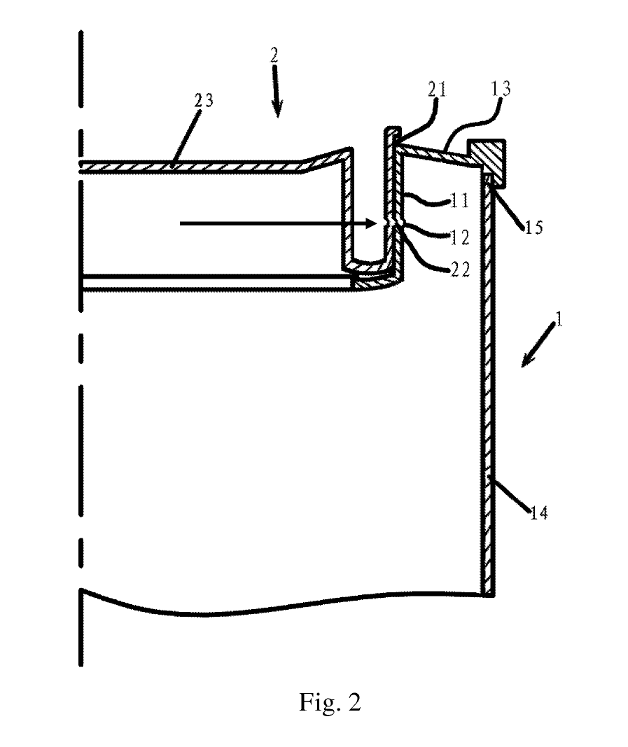

According to the process of the invention, when a canned paint product is to be produced, the can 1, lid 2 and paint are provided, and then the paint is filled in the can 1. Next, the lid 2 is fitted in the mouth 13 of the can 1, generally by being pressed into the mouth 13, such that the extension 21 of the lid 2 forms a relatively tight press-fit with the sidewall 11 of the mouth 13. However, a force produced by such a press-fit is generally not great enough, thus the lid tends to escape from the can when the canned product is subject to shake or tipped over. For this reason, in the process according to the invention, after the lid 2 is fitted in the mouth 13 of the can 1, as shown in FIGS. 2 and 3, at least one bulge 22 is made on the extension 21 of the lid 2, a convex surface of which bulge is engaged with the sidewall 11 of the mouth 13, such that the extension 21 and/or the sidewall 11 will be destroyed while the lid 2 is removed from the can, that is, since the convex surface of the bulge 22 is engaged with the sidewall 11, it will tightly abut against and slide on the sidewall 11 while the lid 2 is removed from the can, thus a relatively high pressing force between the bulge and the sidewall will produce a visible evidence (scratch mark) on the sidewall 11, and at the same time the convex surface of the bulge 22 will also be destroyed (squashed and/or scratched, for example) due to the pressing force.

Thus, on the one hand, a more reliable engagement between the bulge 22 of the extension 21 and the sidewall 11 increases the fit force between the lid 2 and the mouth 13 of the can 1, thereby reducing the probability that the lid will escape from the can. On the other hand, it can be recognized whether or not the canned product is counterfeit by checking whether any bulge 22 exists on the lid 2; in addition, since the sidewall 11 of the mouth 13 and the bulge 22 on the extension 21 have been destroyed after the lid is removed from the can, the can and the lid cannot be reused; or alternatively, it can be easily determined whether the lid has ever been removed from the can by checking if a visible evidence exists or not.

In the embodiment, as shown in FIG. 2, after the lid 2 has been fitted in the mouth of the can 1, bulges 22 are protruded by extending parts of the surface of the extension 21 of the lid 2 in the direction towards the sidewall 11 (the direction as indicated by the arrow in FIG. 2). Here, the protrusion of the bulges 22 is accomplished by deforming the material in specific areas of the extension 21. Such a deformation by extending may be easily carried out by any proper tool or means known in the art according to the specific configurations of the lid and the mouth of the can. In the embodiment, in order to increase and evenly distribute the fit force between the lid 2 and the mouth 13, as shown in FIG. 3, five bulges 22 are equidistantly formed along the circumference of the lid. However, the number and arrangement of the bulges 22 are not specifically limited, and may be arbitrarily varied as desired, such that it is possible to adjust the magnitude and distribution of the fit force between the lid and the can. Preferably, the five bulges 22 are substantially in the same plane. As shown in FIG. 2, in a preferable mode, the convex surface of the bulge 22 is formed as a smooth surface without any sharp protrusion, so as to prevent the protection film, possibly existing on the back side of the lid 2 and protecting the lid from corrosion by the paint, from being damaged when the bulges are formed. Advantageously, while the extension 21 of the lid 2 is being extended, the bulges 22 press the sidewall 11 which fits with the extension 21, such that five concaves 12 are correspondingly formed on the sidewall 11, wherein respective bulge 22 and respective concaves 12 are engaged with each other with matching shapes, thereby the fit force between the lid and the mouth is further increased. However, the concaves 12 are not necessarily formed on the sidewall 11, and the technical effects of the invention may be achieved as long as the formed bulges can be engaged with the sidewall while the lid is removed from the can to such an extent that is enough to destroy the extension 21 and/or the sidewall 11.

In the above embodiment, the bulges 22 are formed on the extension 21 of the lid 2. However, the invention is not limited to this, and the bulges may also be formed on the sidewall of the mouth 13 to be engaged with the extension of the lid while the lid is removed, for example, this depending on the specific configurations of the lid and the mouth as well as the workability for forming the bulges. In the above embodiment, after the lid is fitted, the mouth 13 of the can 1 surrounds the extension 21 of the lid 2, such that the bulges 22 may be protruded by extending parts of the surface of the extension 21 of the lid 2 in the direction towards the sidewall 11. However, the invention is not limited to this, and in the case where the extension 21 of the lid surrounds the mouth 13, the bulges 22 may be protruded by drawing together parts of the surface of the extension 21 in the direction towards the sidewall 11, and herein the bulges 22 protrude towards the center of the lid.

It will be understood that, the invention is not limited to the exemplary embodiment as described hereinabove and various modifications can be made by the skilled in the art without departing from the scope and spirits of the invention.

1. A process for producing a canned product, comprising the steps of:
(a) providing a can, a lid and contents to be filled in the can, the can having a mouth, and the lid having an extension that is able to fit the mouth to seal the can;
(b) filling the can with the contents;
(c) fitting the lid in the mouth of the can, such that the extension of the lid forms a fit with a sidewall of the mouth;
and
(d) forming at least one bulge on one of the extension of the lid and the sidewall of the mouth after fitting the lid in the mouth of the can, wherein while the lid is removed from the can, the convex surface of the at least one bulge is engaged with the other of the extension of the lid and the sidewall of the mouth in such a way that the extension and/or the sidewall is destroyed.

2. The process according to claim 1, wherein the step (d) comprises extending parts of the surface of the extension of the lid in the direction towards the sidewall such that the at least one bulge is protruded.

3. The process according to claim 2, wherein each of the at least one bulge generates a concave on the sidewall while the extension is being extended, the concave and the bulge being engaged with each other via their matching shapes.

4. The process according to claim 1, wherein a plurality of the bulges are formed.

5. The process according to claim 4, wherein at least five bulges are formed.

6. The process according to claim 4, wherein the plurality of the bulges are evenly distributed along the circumference of the lid or the mouth.

7. The process according to claim 1, wherein the convex surface of the bulge is formed as a smooth surface without any sharp protrusions.

8. The process according to claim 1, wherein the mouth includes a collar that is fixedly disposed on the can body of the can.

9. The process according to claim 1, wherein the contents are paint.

10. A canned product produced by the process according to claim 1, the canned product comprising a can having a mouth, a lid having an extension, and contents filled in the can, the lid being fitted in the mouth such that the extension forms a fit with a sidewall of the mouth to seal the can, characterized in that, wherein one of the extension of the lid and the sidewall of the mouth has at least one bulge, and while the lid is removed from the can, the convex surface of the at least one bulge is engaged with the other of the extension of the lid and the sidewall of the mouth in such a way that the extension and/or the sidewall is destroyed.

11. The canned product according to claim 10, wherein the at least one bulge is protruded by extending parts of the surface of the extension of the lid in the direction towards the sidewall.

12. The canned product according to claim 11, wherein the sidewall is formed with at least one concave, which corresponds to the at least one bulge one to one and is engaged therewith via their matching shapes.

13. The canned product according to claim 10, wherein a plurality of the bulges are formed.

14. The canned product according to claim 13, wherein at least five bulges are formed.

15. The canned product according to claim 13, wherein the plurality of the bulges are evenly distributed along the circumference of the lid or the mouth.

16. The canned product according to claim 10, wherein the convex surface of the bulge is formed as a smooth surface without any sharp protrusions.

17. The canned product according to claim 10, wherein the mouth includes a collar that is fixedly disposed on the can body of the can (1).

18. The canned product according to claim 10, wherein the mouth and/or the lid is made of metal.

19. The canned product according to claim 10, wherein the contents are paint.
